(19) United States
(12) Patent Application Publication
(10) Pub. No.: US 2008/0304792 A1
(43) Pub. Date: Dec. 11, 2008

(54) ADAPTER FIXATION STRUCTURE, ADAPTER FIXATION METHOD AND ELECTRONIC DEVICE WITH ADAPTER FIXATION STRUCTURE

(76) Inventor: SADAAKI MIYAMOTO, Tokyo (JP)

Correspondence Address: NEC CORPORATION OF AMERICA, 6535 N. STATE HWY 161, IRVING, TX, 75039, US

(21) Appl. No.: 12/050,273

(22) Filed: Mar. 18, 2008

(30) Foreign Application Priority Data
Mar. 19, 2007 (JP) 2007-070484

(51) Int. Cl. G02B 6/38

(52) U.S. Cl. 385/71

(57) ABSTRACT

The present invention is to provide an adapter mounting structure in which the degree of freedom of mounting an adapter is high, which has a mechanism simple and uncomplicated in the structure, in which adapter mounting and assembly work are easily performed, and which can be manufactured at low cost, an adapter mounting method, and an electronic device with the adapter mounting structure. An adapter fixation structure for fixing an adapter 6 including a sheet metal part 5 including a front support hole, and a sheet metal part 4 which is disposed in parallel with the sheet metal part 5 and has a rear support hole at a place where a penetrating shaft from the front support hole is tilted from the vertical direction with regard to the sheet metal part 5, wherein the adapter 6 is inserted from the front support hole to the rear support hole along with the penetrating shaft, and is held and fixed to the sheet metal part 5 while being tilted from the vertical direction.

This application is based upon and claims the benefit of priority from Japanese patent application No. 2007-070484, filed on Mar. 19, 2007, the disclosure of which is incorporated herein in its entirety by reference.

### BACKGROUND OF THE INVENTION

1. Field of the Invention

The present invention relates to an adapter fixation method, an adapter fixation structure, and an electronic device with the adapter fixation structure.

2. Description of the Related Art

An optical transmission device is connected to another optical communication device through an optical fiber. For connection of the optical fiber, various connectors based on various standards and configurations are used such as an SC (Single Coupling/Subscriber Connector/Standard Connector) adapter and an SC plug, and an MU (Miniature Unit coupling) adapter and an MU plug which are of generally-standardized connector configurations, and DS (Fiber optic connector for Digital System), MPO (Multi-fiber Push-On), LC (Lucent Connector/Local Connector), and FC (Ferrule Connector) adapters/plugs.

When installing and operating the optical transmission device, an optical connector plug is plugged and unplugged as necessary, and therefore, in many cases, these optical adapters are disposed on a front panel of the optical transmission device for convenience.

For fixation of an individual optical adapter, in general, a method for fixing a flange of the adapter using screws as shown in FIG. 1 and FIG. 2, and a method for fixing the optical adapter to a panel using a method for inserting the same into a square hole of a plate as shown in FIG. 3 are employed. When being inserted to the square hole as shown in FIG. 3, the adapter is likely to be loosened and therefore, is fixed by screws in many cases for the purpose of tight fixation. However, when screws are used, screw thread cutting is necessary on the mounted side, which involves screw fixation work at the time of adapter mounting. The screw thread cutting and screw fixation work increase in proportion to an increase in the number of adapters.

In many cases, an adapter is mounted obliquely with regard to a front panel of the device (for example, see Japanese Patent Application Laid-Open No. H2-58004). This configuration allows elimination of unnecessary protrusion of cables to be connected to the device from an external surface of the device when the device is disposed in a closed narrow space such as a closed rack, and optical cables can be led to the outside of the rack in a natural way. Further, there is such an advantage that a person (operator) facing with the device is prevented from directly looking a light emitted from the device.

In recent years, market needs for small-sized devices have been increasing in the field of optical transmission devices. An important factor here is how to mount devices and systems efficiently in a limited physical space. This promotes miniaturization of devices and high-density mounting of electronic parts in the device. High-density mounting of optical transmission devices results in increasing number of interfaces (ports) in the optical transmission devices, and a large number of optical adapters need to be disposed on the device panel plane. In other words, high-density mounting of adapters on the device panel plane becomes necessary. To realize the high-density mounting of these adapters on the device panel plane, the pitch of mounting should be shortened (for example, see Japanese Patent Application Laid-Open No. 2002-48946 and Japanese Patent Application Laid-Open No. H11-250977).

When an adapter is mounted obliquely to a panel plane in a high-density manner, the following problems arise:

In the methods shown in FIGS. 1, 2, 3, each of adapters is inserted and fixed perpendicularly to a plate plane at a fixation place. For this reason, in order to mount a plurality of adapters obliquely to the panel plane, tilted adapter mounting planes are required on the panel plane of the device. That is, a panel which includes a plurality of planes tilted from the device panel plane in accordance with the number of adapters to be mounted is necessary. Specifically, it is necessary to use parts shown in FIG. 4 that is produced by bending a plate (panel) in a complicated manner or a plurality of parts shown in FIG. 5.

In addition, as described above, each of adapters requires a structure (fixation by screw) for fixation to the panel without causing looseness.

When a fixation structure corresponding to each of adapters is incorporated to a panel parts of a complicated structure to which such a tilted plane is provided for the sake of securement of required strength, there is a problem as a result that a pitch between adapters is widened and mounting density is not increased. Another problem is such that the number of parts increases in proportion to the number of adapters to be mounted, and fine fixation work using screws to panels with complicated shape is required when assembling. These problems result directly in increased costs.

In consideration of the above-described problems, the present invention is proposed.

### SUMMARY OF THE INVENTION

An object of the present invention is to provide an adapter mounting structure in which the degree of freedom of mounting an adapter is high, which has a mechanism simple and uncomplicated in the structure, in which adapter mounting and assembly work are easily performed, and which can be manufactured at low costs, an adapter mounting method, and an electronic device with the adapter mounting structure.

An adapter fixation structure for fixing an adapter including: a front plate part including a front support hole; and a rear plate part which is disposed in parallel with the front plate part and includes a rear support hole at a place where a penetrating shaft from the front support hole is tilted from vertical direction with regard to the front plate part, wherein the adapter is inserted from the front support hole to the rear support hole along with the penetrating shaft, and is held and fixed to the front plate part while being tilted from vertical direction.

The electronic device of the present invention is characterized by including the adapter fixation structure of the present invention.

An adapter fixation method for fixing an adapter, wherein a front plate part including a front support hole and a rear plate part including a rear support hole are disposed in parallel at a place where a penetrating shaft ranging from the front support hole to the rear support hole is tilted from the vertical direction with regard to the front plate part, and the adapter is inserted from the front support hole to the rear support hole along with the penetrating shaft, and is held and fixed to the front plate part while being tilted from the vertical direction.

According to the present invention, it is possible to provide an adapter mounting structure in which the degree of freedom of mounting an adapter is high, which has a mechanism simple and uncomplicated in the structure, in which adapter mounting and assembly work are easily performed, and which can be manufactured at low costs, an adapter mounting method, and an electronic device with the adapter mounting structure.

### BRIEF DESCRIPTION OF THE DRAWINGS

FIG. 1 is a drawing showing one example of a mounting and fixation method for each adapter;

FIG. 2 is a drawing showing one example of a mounting and fixation method for each adapter;

FIG. 3 is a drawing showing one example of a mounting and fixation method for each adapter;

FIG. 4 is a drawing showing one example of an adapter mounting structure in a tilted state;

FIG. 5 is a drawing showing one example of an adapter mounting structure in a tilted state;

FIG. 6 is a drawing showing an example of an optical transmission device according to an exemplary embodiment of the present invention;

FIG. 7 is a drawing showing an example of the optical transmission device according to the exemplary embodiment of the present invention;

FIG. 8 is an exploded view showing assembly of the adapter mounting structure according to the exemplary embodiment of the present invention;

FIG. 9 is a detailed drawing showing the adapter mounting structure according to the exemplary embodiment of the present invention; and

FIG. 10 is a detailed drawing showing an upper part of the adapter mounting structure according to the exemplary embodiment of the present invention.

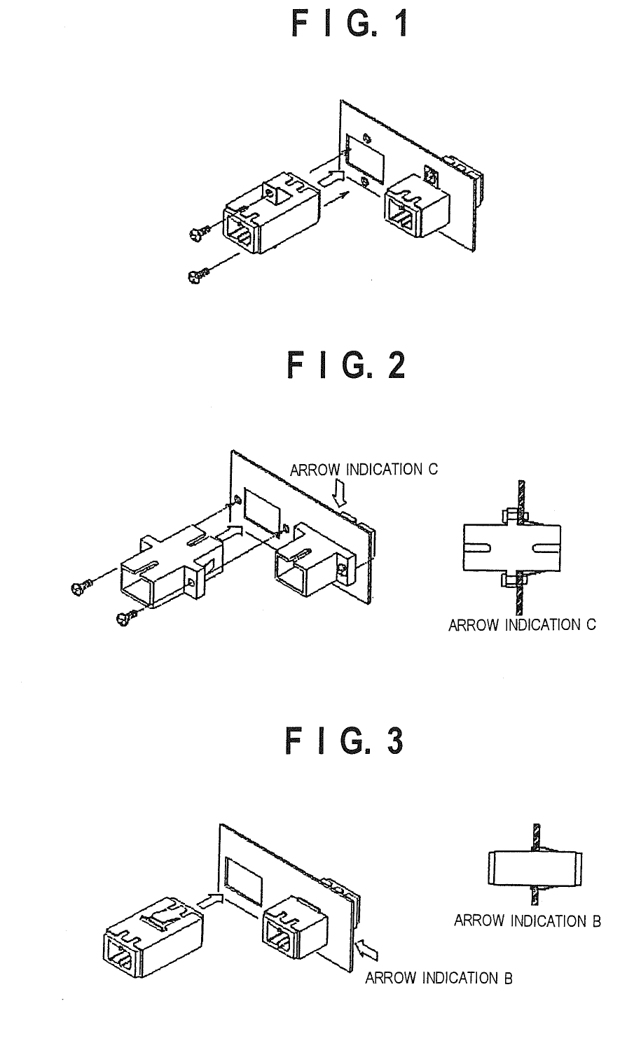

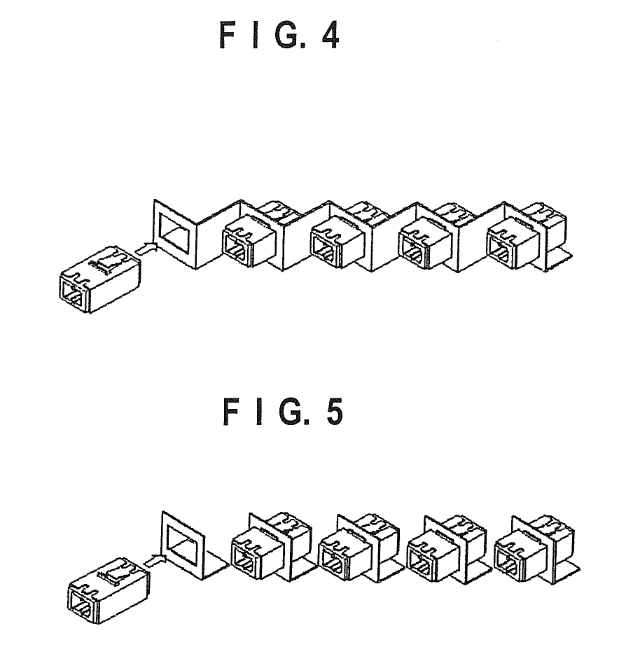

### EXEMPLARY EMBODIMENT

An adapter fixation structure for fixing an adapter of the present invention includes a front plate part including a front support hole, and a rear plate part which is disposed in parallel with the front plate part and includes a rear support hole at a place where a penetrating shaft from the front support hole is tilted from vertical direction with regard to the front plate part. The adapter is inserted from the front support hole to the rear support hole along with the penetrating shaft, and is held and fixed to the front plate part while being tilted from vertical direction. This configuration realizes an adapter mounting structure in which the degree of freedom of mounting an adapter is high, which has a mechanism simple and uncomplicated in the structure, in which adapter mounting and assembly work are easily performed, and which can be manufactured at low costs.

This is because, thanks to the adapter fixation structure including a panel and a parallel plane, a tilted plane corresponding to an adapter mounting angle and complicated structural elements composing the tilted plane are excluded from the adapter mounting structure.

Referring now to the drawings, an exemplary embodiment of the present invention will be explained in detail hereinafter.

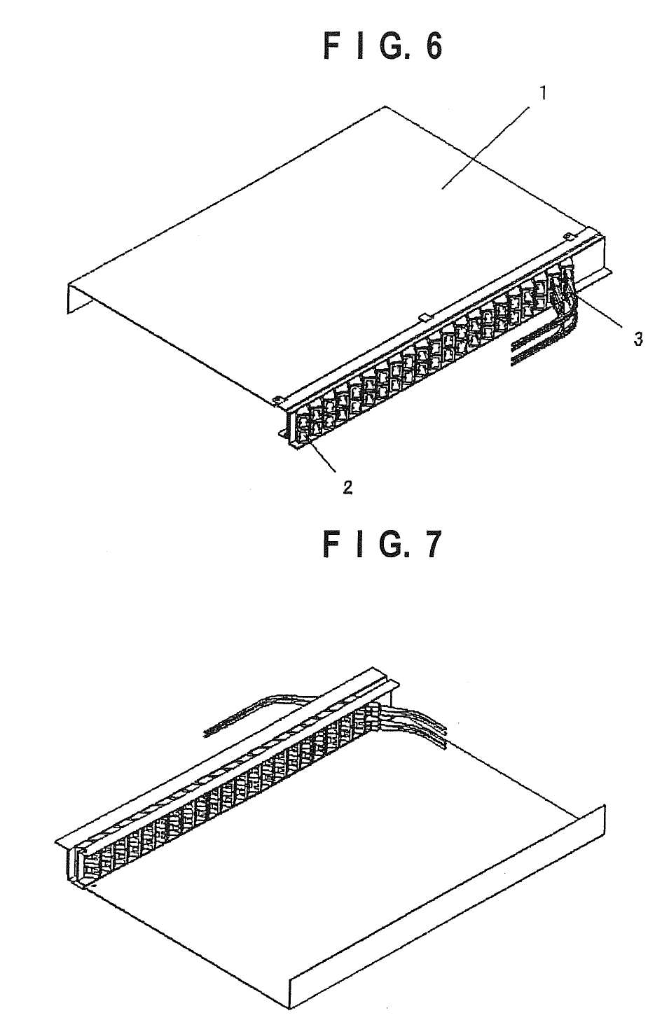

An optical transmission device according to the present embodiment is shown in FIG. 6. In FIG. 6, one of packages (package 1) of the optical transmission device is specifically picked up in order to illustrate a mounting structure of an optical adapter being disposed on a panel plane. FIG. 6 shows an example of a fixation structure of an MU adapter 2 corresponding to a two-core MU plug 3. FIG. 7 is a drawing showing an opposite plane (rear plane) of the package 1 shown in FIG. 6 from the depth direction in FIG. 6. As shown in FIG. 6, according to the present embodiment, a number of adapters are mounted in a high-density manner while being tilted with regard to the panel of the device.

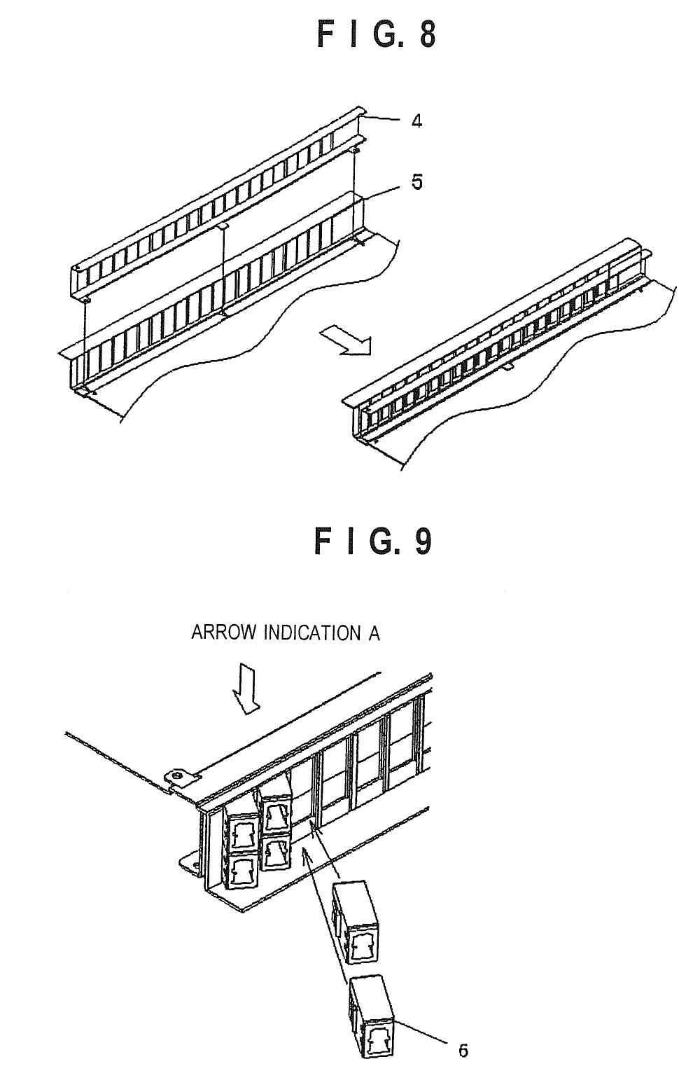

FIGS. 8, 9, 10 are exploded views of the adapter mounting structure of the present embodiment.

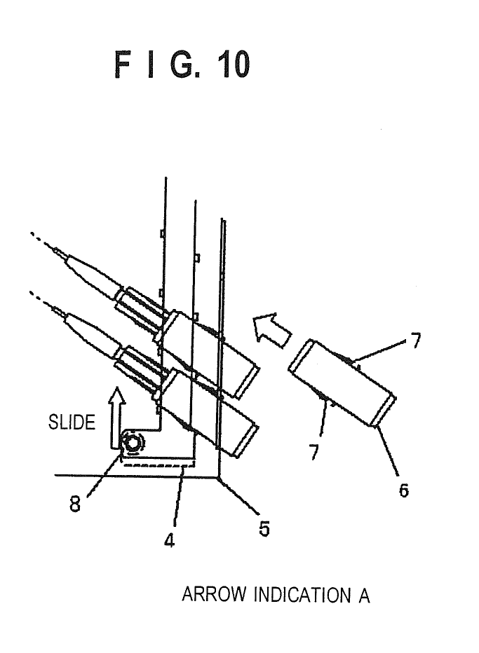

FIG. 8 is an exploded view showing assembly of the adapter mounting structure, FIG. 9 is a drawing showing a state where an adapter is assembled to the adapter mounting structure being assembled, and FIG. 10 is an arrow-indication view viewed from the above of FIG. 9 (corresponding to the arrow A shown in FIG. 9).

As shown in FIG. 8, the primary part of the adapter fixation structure of the present embodiment is composed of two sheet metal parts 4, 5 for fixation of the adapter. The two sheet metal parts 4, 5 correspond to the panel portion of the device in FIG. 6.

A plurality of openings (adapter support holes) is provided for each of the sheet metal parts 4, 5. In the present embodiment, this opening includes a square hole shape corresponding to a two-core MU adapter. Since a plurality of square holes is provided for each of the sheet metal parts 4, 5, the sheet metal parts 4, 5 are in a lattice shape or slit shape as a result.

The two sheet metal parts 4, 5 are assembled as shown in the right illustration in FIG. 7. Upon completion of assembly, as shown in FIG. 10, each of openings is shifted from each other. That is, if viewed from the front vertical direction of the sheet metal parts 4, 5, the opening of the sheet metal part 4 and the opening of the sheet metal part 5 corresponding thereto while being closer to the rear thereof are not aligned, resulting in a shifted positional relationship.

As a result, as shown in FIG. 9, when an adapter 6 is inserted so as to be penetrating through the opening of the sheet metal part 4 and the opening of the sheet metal part 5 corresponding thereto, the adapter 6 is fixed with an angle tilted with regard to the sheet metal part 4 and sheet metal part 5.

As shown in FIG. 10, the adapter 6 includes a latch structure 7 at a side wall part thereof. This latch structure 7 includes a spring structure and is pressed into the opening when the adapter 6 is inserted therein, is lifted up after insertion, and a front edge of the spring is engaged with the interior of each of the sheet metal parts 4, 5, and the adapter 6 is unable to escape easily from a fixed state.

Alternatively, at the time of mounting the adapter 6, the sheet metal part 5 is provided with an allowance by loosening the shifting from the sheet metal part 4, and then is moved after the adapter 6 is mounted, so that the adapter 6 is fixed more tightly. In other words, in FIG. 10, the sheet metal part 4 is moved from the position shown by the dotted line in the direction of the arrow identified by “slide”, and the sheet metal part 4 may be fixed by a screw 8 while the adapter 6 thus mounted is fastened further, grasped and held. This configuration allows easy mounting of the adapter due to an appropriate allowance at the time of mounting, the allowance is removed at the time of fixation after mounting, and the adapter 6 can be fixed securely.

As described above, according to the present embodiment, the adapter is fixed by disposing the openings (adapter support holes) of the front and rear sheet metal parts in a shifted manner, so that the adapter can be fixed in a tilted state without using complicated structures which include a tilted plane.

Meanwhile, the above-described embodiment is one example of the preferred embodiment of the present invention, and should not be construed to limit the present invention in any manner whatsoever.

For example, although the two-core MU adapter is exemplified in the above-described embodiment, the adapter may be of a two-core type or a single core type. Further, adapters with profiles other than the MU adapters may be used. In addition, although the two-core and one-row example is shown in above-described embodiment, one-core and one-row may be used. Rows may be increased in the longitudinal direction irrespective of one-core and two-core. Shapes of corresponding adapters, and arrangement and number of adapters can be changed flexibly depending on shapes, arrangement, and number of openings to be provided for the sheet metal parts 4, 5.

The latch structure of the adapter 6 is not limited to the previously mentioned spring structure. As for the spring structure, in addition to the plate spring, for example, a coil spring may be used. In addition, an elastic body, an elastic structure, and a mechanism integrally formed (using the same material as) with a housing of the adapter 6 to constitutionally latch the adapter may be used.

In the above-described embodiment, such an example is exemplified that the sheet metal part 4 is slid after the adapter 6 is mounted, and is held and fixed by grasping the adapter 6. However, the method for moving the sheet pale parts for adjustment is not limited thereto. For example, the sheet metal part 5 may be slid in place of the sheet metal part 4. Alternatively, such a mechanism in which both the sheet metal parts 4, 5 are slid may be used. Although an example in which the direction of sliding is in parallel with the plane of the sheet metal part 4 is shown in the above-described embodiment, the direction of sliding and movement related matters are not limited as long as the positional relationship of the openings of the sheet metal parts 4, 5 is changed and as a result, the fixation state of the adapter 6 can be adjusted. For example, movement for changing a distance (interval) between the sheet metal parts 4 and 5, up/down and right/left movement, or parallel movement in which these directions are combined arbitrarily, rotational movement of the sheet metal parts 4 and 5, and further, movement of combination thereof may be used.

Further, in the above-described embodiment, an example in which the sheet metal part 4 is slid for fastening and fixation of the adapter 6 at the time of the mounting work of the adapter 6 is exclusively shown. However, the adjustment by movement of the sheet metal parts 4, 5 as described above may be substituted by a mechanism by which the inclination angle or the like of the adapter 6 being fixed is adjusted. In other words, such a mechanism may be used that the inclination angle and inclination direction with regard to the panel plane of the adapter 6 that is already in a fixed state, or the degree of protrusion and sinking of the adapter 6 from the panel plane (sheet metal part 5) are changed or adjusted arbitrarily, by changing the shifted condition and positional relationship of the openings of the sheet metal parts 4 and 5 at the time of use of the device.

As described above, in the present invention, even if a number of adapters are obliquely mounted in a high-density manner at narrower pitches, there can be realized a mechanism which is simple and uncomplicated, and a structure in which a method for mounting the adapter to the panel is simple, parts relating to the mechanism and mounting work are easy, the manufacturing cost is low, and the degree of freedom of mounting is high.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An adapter fixation structure for fixing an adapter comprising:
a front plate part including a front support hole; and
a rear plate part which is disposed in parallel with the front plate part and includes a rear support hole at a place where a penetrating shaft from the front support hole is tilted from vertical direction with regard to the front plate part, wherein
the adapter is inserted from the front support hole to the rear support hole along with the penetrating shaft, and is held and fixed to the front plate part while being tilted from vertical direction.

2. The adapter fixation structure according to claim 1, wherein
the adapter comprises a latch claw part at a side wall, at least a part of the latch claw part is engaged with the front support hole and at least the other part of the latch claw part is engaged with the rear support hole.

3. The adapter fixation structure according to claim 2, wherein
the latch claw part includes a mechanism by an elastic member which is biased and sunk when the adapter is mounted to the adapter fixation part, and is protruded at the time of fixing, and is engaged with the front support hole and the rear support hole.

4. The adapter fixation structure according to claim 3, wherein
the mechanism by the elastic member is a mechanism by a spring.

5. The adapter fixation structure according to claim 1, wherein
the rear plate part is slid in the plane direction of the rear plate part for fastening and grasping the adapter.

6. An electronic device characterized by including the adapter fixation structure according to claim 1.

7. An adapter fixation method for fixing an adapter, wherein
a front plate part including a front support hole and a rear plate part including a rear support hole are disposed in parallel at a place where a penetrating shaft ranging from the front support hole to the rear support hole is tilted from the vertical direction with regard to the front plate part, and the adapter is inserted from the front support hole to the rear support hole along with the penetrating shaft, and is held and fixed to the front plate part while being tilted from the vertical direction.

8. The adapter fixation method according to claim 7, wherein
the adapter comprises a latch claw part at a side wall, at least a part of the latch claw part is engaged with the front support hole and at least the other part of the latch claw part is engaged with the rear support hole.

9. The adapter fixation method according to claim 8, wherein
the latch claw part is biased and sunk by a mechanism by an elastic member when the adapter is mounted to the adapter fixation part, and is protruded at the time of fixing, and is engaged with the front support hole and the rear support hole.

10. The adapter fixation method according to claim 9, wherein
the mechanism by the elastic member is a mechanism by a spring.

11. The adapter fixation method according to claim 8, wherein
the rear plate part is slid in the plane direction of the rear plate part for fastening and grasping the adapter.
